(19) United States
(12) Patent Application Publication
(10) Pub. No.: US 2026/0051581 A1
(43) Pub. Date: Feb. 19, 2026

(54) ENERGY STORAGE ELEMENT AND METHOD FOR PRODUCING AN ENERGY STORAGE ELEMENT

(71) Applicant: VARTA Microbattery GmbH, Ellwangen Jagst (DE)

(72) Inventors: Verena Drews, Giengen (DE); Waldemar Frank, Ellwangen (DE); Michael Geiger, Ellwangen (DE); Dominik Kieninger, Rainau (DE); Patrick Rieker, Ellwangen (DE)

(21) Appl. No.: 19/295,846

(22) Filed: Aug. 11, 2025

(30) Foreign Application Priority Data
Aug. 13, 2024 (EP) 24194421

(51) Int. Cl. H01M 50/152; H01M 10/0525; H01M 10/0587; H01M 50/107; H01M 50/169; H01M 50/171

(52) U.S. Cl. CPC H01M 50/152; H01M 10/0525; H01M 10/0587; H01M 50/107; H01M 50/169; H01M 50/171

(57) ABSTRACT

An energy storage element includes a housing that defines a longitudinal axis and an interior and comprises a metallic housing cup and a cover assembly that closes the housing cup. A seal arrangement having a seal radially encloses the cover assembly and seals against the housing cup. An electrode-separator composite has an anode, a separator, and a cathode. The anode includes an anode current collector, and the cathode includes a cathode current collector. A contact plate part is seated on a protrusion of the anode current collector and covers the first terminal end face of the electrode-separator composite and is connected thereto or is seated on a protrusion of the cathode current collector and covers the second terminal end face of the electrode-separator composite and is connected thereto. The housing cup is formed without a tool engagement structure.

### CROSS REFERENCE TO RELATED APPLICATIONS

This application claims benefit to European Patent Application No. EP 24194421.4, filed on Aug. 13, 2024, which is hereby incorporated by reference herein.

### FIELD

The present disclosure relates to energy storage elements having a housing with a metallic housing cup and a cover assembly that closes the housing cup. The present disclosure further relates to methods of production for such energy storage elements.

### BACKGROUND

An energy storage element of the type mentioned at the outset is described, for example, in European patent application number 23190399.8 of the present applicant.

Electrochemical energy storage elements are capable of converting stored chemical energy into electrical energy by a redox reaction. The simplest form of an electrochemical energy storage element is the electrochemical cell (also referred to hereinafter as an energy storage cell). It comprises a positive and a negative electrode, which are connected to one another via an ion-conducting electrolyte. A separator can be arranged between the electrodes for electrical isolation. During a discharge, electrons are released at the negative electrode by an oxidation process. An electron current results therefrom, which can be tapped by an external electrical consumer, for which the electrochemical cell is used as an energy supplier. At the same time, an ion current corresponding to the electrode reaction occurs via the ion-conducting electrolytes within the cell.

Energy storage elements can comprise more than one single electrochemical cell, for example, two or more energy storage cells connected to one another in parallel or in series. Such an energy storage element having multiple cells is also referred to as a battery.

If the described discharge is reversible, thus there is the possibility of reversing the conversion of chemical energy into electrical energy which took place during the discharge again and recharging the cell, this is referred to as a secondary cell. The designation of the negative electrode as the anode and the designation of the positive electrode as the cathode, which is typical in general for secondary cells, refers to the discharge function of the electrochemical cell.

Secondary lithium-ion cells are currently used for many applications as energy storage elements, since they can provide high currents and are distinguished by a comparatively high energy density. They are based on the use of lithium, which can travel back and forth between the electrodes of the cell in the form of ions. The negative electrode and the positive electrode of a lithium-ion cell are generally formed by so-called composite electrodes, which also comprise electrochemically inactive components in addition to electrochemically active components.

In principle, all materials which can absorb lithium ions and discharge them again come into consideration as electrochemically active components (active materials) for secondary lithium-ion cells. For this purpose, for example, particles based on carbon, such as graphitic carbon, are used for the negative electrode. For example, lithium cobalt oxide (LiCoO₂), lithium manganese oxide (LiMn₂O₄), lithium iron phosphate (LiFePO₄), or derivatives thereof can be used as active materials for the positive electrode. The electrochemically active materials are generally contained in particle form in the electrodes.

As electrochemically inactive components, the composite electrodes generally comprise a planar and/or band-shaped current collector, for example, a metallic foil, which is used as the carrier for the respective active material. The current collector for the negative electrode (anode current collector) can be formed, for example, from copper or nickel and the current collector for the positive electrode (cathode current collector) can be formed, for example, from aluminium.

Furthermore, the electrodes can comprise, as electrochemically inactive components, an electrode binder (e.g., polyvinylidene fluoride (PVDF) or another polymer, for example, carboxymethylcellulose), conductivity-improving additives, and other additives. The electrode binders ensure the mechanical stability of the electrodes and often also the adhesion of the active material on the current collectors.

Lithium-ion cells usually comprise solutions of lithium salts such as lithium hexafluorophosphate (LiPF₆) in organic solvents (such as ethers and esters of carbonic acid) as electrolytes.

The composite electrodes are generally combined with one or more separators to form an electrode-separator composite during the production of a lithium-ion cell. In this case, the electrodes and separators are often, but in no way necessarily, connected to one another under pressure, possibly also by lamination or by adhesive bonding. The fundamental functional capability of the cell can then be produced by impregnating the composite with the electrolyte.

The electrode-separator composite is often formed in the form of a winding or processed to form a winding. In the first case, for example, a band-shaped positive electrode and a band-shaped negative electrode and at least one band-shaped separator are separately fed to a winding machine and wound therein in a spiral shape to form a winding having the sequence positive electrode/separator/negative electrode. In the second case, a band-shaped positive electrode and a band-shaped negative electrode and at least one band-shaped separator are initially combined to form an electrode-separator composite, for example, with application of the mentioned pressure. In a further step, the composite is then wound.

For applications in the automotive sector, for E-bikes, or also for other applications having a high energy demand, for example, in electrical tools, lithium-ion cells having the highest possible energy density are required, which are capable at the same time of being loaded with high currents during charging and discharging.

Energy storage cells having an electrode-separator composite in the form of a winding for the mentioned applications are formed as cylindrical round cells, which often have a length or height between 50 mm and 150 mm and a diameter in the range of 15 mm to 60 mm. Modern lithium-ion cells having, for example, the form factor 21×70 (diameter by height in mm) can achieve an energy density of up to 270 Wh/kg.

The volume proportion of the interior of the housing which can be used for the winding is particularly important with regard to the capacity and performance of an energy storage cell. The greater this volume is, with dimensions and components of the energy storage cell unchanged except for the winding, the higher is its capacity and performance, if a correspondingly larger winding is arranged in a larger volume.

### SUMMARY

In an embodiment, the present disclosure provides an energy storage element including a housing comprising a metallic housing cup and a cover assembly that closes the housing cup, the housing defining a longitudinal axis and an interior. The energy storage element also includes a seal arrangement comprising a seal that radially encloses the cover assembly and seals against the housing cup, wherein the seal is compressed against the cover assembly by a free end section of the housing cup that is bent over radially inward. The energy storage element additionally includes an electrode-separator composite having a sequence anode/separator/cathode/separator, the electrode-separator assembly being housed in the housing cup and is provided in the form of a cylindrical winding. The anode comprises an anode current collector having a band-shaped main area loaded with a layer of negative electrode material and a free edge strip not loaded with the negative electrode material, the anode current collector further having a first longitudinal edge, wherein the free edge strip emerges from a first terminal end face of the electrode-separator composite and forms a protrusion at the first end face. The cathode comprises a cathode current collector having a band-shaped main area loaded with a layer of positive electrode material, and a free edge strip not loaded with the positive electrode material, the cathode current collector further having a first longitudinal edge, wherein the free edge strip emerges from a second terminal end face of the electrode-separator composite and forms a protrusion at the second end face. The energy storage element further includes a contact plate part, wherein: the contact plate part is seated on the protrusion of the anode current collector and covers the first terminal end face of the electrode-separator composite and is connected thereto; or the contact plate part is seated on the protrusion of the cathode current collector and covers the second terminal end face of the electrode-separator composite and is connected thereto. In the energy storage element, the protrusion connected to the contact plate part is a protrusion compressed in the axial direction, and the housing cup is formed without a tool engagement structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a longitudinal section through an energy storage cell according to the prior art, which comprises a housing having a tool engagement structure in the form of a circumferential tool engagement bead;

FIG. 2 shows an electrode-separator composite and its components;

FIG. 3 shows a longitudinal section through an energy storage cell having a housing without tool engagement structure according to a first embodiment;

FIG. 4 shows a longitudinal section through an energy storage cell having a modification of the embodiment according to FIG. 3;

FIG. 5 shows a longitudinal section through an energy storage cell according to a second embodiment;

FIG. 6 shows a longitudinal section through an energy storage cell according to a third embodiment; and

FIG. 7 shows a longitudinal section through an energy storage cell according to a fourth embodiment.

### DETAILED DESCRIPTION

The present disclosure provides an energy storage element, in particular an energy storage cell, and a method adapted thereto.

The present disclosure provides an energy storage element having:
a) a housing, which defines a longitudinal axis of the energy storage element and an interior and comprises a metallic housing cup and a cover assembly, which closes the housing cup;
b) a seal arrangement having a seal, which radially encloses the cover assembly and seals it in relation to the housing cup, wherein the seal is compressed against the cover assembly by a free end section of the housing cup which is bent over radially inward;
c) an electrode-separator composite having the sequence anode/separator/cathode/separator, which is housed in the housing cup and is provided in the form of a cylindrical winding, wherein
c1) the anode comprises an anode current collector, which has a band-shaped main area loaded with a layer made of negative electrode material, and which has a free edge strip, which is not loaded with the electrode material and comprises a first longitudinal edge of the anode current collector, wherein the free edge strip emerges from a first terminal end face of the electrode-separator composite and forms a protrusion at the first end face;
c2) the cathode comprises a cathode current collector, which has a band-shaped main area loaded with a layer made of positive electrode material, and which has a free edge strip, which is not loaded with the electrode material and comprises a first longitudinal edge of the cathode current collector, wherein the free edge strip emerges from a second terminal end face of the electrode-separator composite and forms a protrusion at the second end face;
d) a contact plate part, which
d1) is seated on the protrusion of the anode current collector and covers the first terminal end face of the electrode-separator composite and is connected thereto;
or
d2) is seated on the protrusion of the cathode current collector and covers the second terminal end face of the electrode-separator composite and is connected thereto.

In the energy storage element:
e) the protrusion connected to the contact plate part is a protrusion compressed in the axial direction;
f) the housing cup is formed without a tool engagement structure.

The housing cup preferably comprises a circular base and a side wall and also a terminal circular opening, which is closed by the cover assembly.

The housing cup of the energy storage element preferably comprises in axial sequence the base, a central section formed by the side wall, and a closure section. In preferred embodiments, at least one of the following features applies:

The central section is formed so as to be hollow-cylindrical.

In the central section, the jacket of the electrode-separator composite formed as a cylindrical winding is in contact with the inner side of the housing cup.

The end section of the housing cup bent over radially inward defines the circular opening.

The cover assembly, including the seal, which is moreover preferably formed ring-shaped, is fixed in a formfitting manner by the end section bent over radially inward in the circular opening of the housing cup.

In particular conventional flanging methods are used in the construction of the energy storage element mentioned at the outset, in order to close the housing cup using the cover assembly. The initially cylindrical free end section of the housing cup is bent over radially inward over an area of the cover assembly here, wherein the seal is compressed. Details in this regard will be explained.

The winding is already located in the housing cup in this case. Among other things, to prevent the winding from being damaged during the flanging method, a tool engagement structure is created in the housing cup in known energy storage elements. The tool engagement structure has the function that a part of a flanging tool can be applied to the housing when the housing cup is closed by the flanging method. During the closing of the housing cup, a countering tool engages as part of the flanging tool in the tool engagement structure, for example, which supports the housing cup in the context of a countering procedure in the axial direction against the force acting during the flanging method and dissipates this force, so that the winding remains substantially free of a force action. A bead which is completely circumferential in the circumferential direction is typically provided in the housing cup for this purpose at the time of the closing, which bead also remains after the production of the energy storage element.

Since this bead protrudes radially into the interior of the housing in relation to the other wall of the housing cup, the area in which the bead is formed is not available for the winding, since it fully fills the housing cup radially.

Bending over the edge strip is described, for example, in European patent application number 23202968.6 of the present applicant with the goal that the radius of the contact plate part can be perceptibly smaller than the winding diameter, in order to reduce the risk that the contact plate part will contact the housing.

However, proceeding beyond this, it was recognized according to the present disclosure that a winding, the edge strip of which connected to the contact plate part is bent over or compressed, buckled, or deformed in another manner in the axial direction, and in general a winding having a protrusion compressed in the axial direction, can be loaded with the forces occurring during the closing of the housing cup without this having negative effects on the function of the energy storage element. Furthermore, it was recognized that a further support against the forces occurring during closing is not necessary and a tool engagement structure can be omitted.

In this way, space becomes free for the winding in the axial direction, so that the energy storage element, in particular the energy storage cell, can be equipped with a winding, with otherwise unchanged internal dimensions, in which the main areas of the anode and the cathode have a greater axial extension. Since these main areas bear the electrode material, this directly increases the capacity and performance of the energy storage element.

In preferred embodiments, band-shaped separators are used for the electrode-separator composite, which are somewhat wider than the electrodes of the winding. The longitudinal edges of these separators preferably lie in one plane and preferably form the end faces of the winding.

It is furthermore preferred for the free edge strips of the current collectors emerging from the terminal end faces of the winding or sides of the stack to protrude in the non-deformed state, thus before the axial compression of the protrusion, by not more than 5500 μm, preferably not more than 4000 μm, from the end faces or the sides. The height of the protrusion of the free edge strips is therefore preferably at most 5500 μm, preferably at most 4000 μm before the axial compression. This applies in particular for cells of the format 21700 (21 mm diameter, 70 mm height).

The free edge strip of the anode current collector preferably protrudes not more than 3000 μm, preferably not more than 2000 μm, from the end face of the winding before the axial compression of the protrusion. The free edge strip of the cathode current collector preferably protrudes not more than 4000 μm, preferably not more than 3000 μm, from the end face of the winding. The height of the protrusion of the free edge strip of the anode current collector is therefore preferably at most 3000 μm, preferably at most 2000 μm, before the axial compression. The height of the protrusion of the free edge strip of the cathode current collector is therefore preferably at most 4000 μm, preferably at most 3000 μm, before the axial compression.

It is preferred that in electrode separator windings, the protrusion of the free edge strip emerging from the first terminal end face of the electrode-separator composite is compressed in the axial direction by at least 10% and at most 80%, preferably by 15% to 60%, preferably by 15% to 50% (in relation to the height of the protrusion before the compression).

It is furthermore preferred that in electrode separator windings, the protrusion of the free edge strip emerging from the second terminal end face of the electrode-separator composite is compressed in the axial direction by at least 10% and at most 80%, preferably by 15% to 60%, preferably by 15% to 50% (in relation to the height of the protrusion before the compression).

A protrusion having an uncompressed height of 3 mm can thus still have, for example, a height of 1.6 mm after the compression.

In the composite body formed as a winding, the band-shaped anode, the band-shaped cathode, and the band-shaped separator or separators are preferably provided wound in a spiral shape. To produce the composite body, the band-shaped electrodes are preferably fed jointly with the band-shaped separator or separators to a winding device and preferably wound therein in a spiral shape around a winding axis. In some embodiments, the electrodes and the separator or separators are wound for this purpose on a cylindrical or hollow cylindrical winding core, which is seated on a winding mandrel and remains in the winding after the winding.

A tool engagement structure is defined in the present case as a structure in the side wall of the housing cup which permits said part of the flanging tool to engage therein for the purpose of carrying out a flanging procedure, in particular for the purpose of carrying out said countering procedure. For this purpose, the structure has to have a minimum depth in the side wall.

Such a tool engagement structure used for a flanging procedure can in particular consist of a ring-shaped indentation of the side wall in the form of the mentioned bead. However, it is also conceivable that a plurality of indentations arranged in a ring shape in the side wall, for example, 3, 4, 6, or 8 indentations, is used as the tool engagement structure.

Conversely, this means that indentations in the side wall which have less than a corresponding minimum depth do not fall under the definition of the term tool engagement structure.

The present disclosure extends to energy storage elements in which the side wall of the housing cup does not have indentations. Furthermore, it extends to energy storage elements in which the side wall of the housing cup has a ring-shaped indentation formed as a bead or multiple indentations arranged in a ring shape, which have less than said minimum depth.

This minimum depth required for the flanging procedure is provided under the following conditions:

The depth of the ring-shaped indentation or the indentations arranged in a ring shape, which are formed as the tool engagement structure, is preferably at least seven times the wall thickness of the housing cup in the area of the indentation or the indentations.

Conversely, this in turn means: Indentations having a depth of less than seven times the wall thickness of the housing cup in the area of the indentation or the indentations are by definition not a tool engagement structure in the meaning of the present application. More preferably, indentations having a depth of less than six times, preferably having a depth of less than five times, more preferably of less than four times, still more preferably of less than three times, and preferably of less than two times the wall thickness of the housing cup in the area of the indentation or the indentations are not a tool engagement structure in the meaning of the present application.

Notwithstanding the depth of a possibly present indentation, a tool engagement structure always also has to be functionally designed for the purpose of cooperating in the above-explained manner with an engagement tool.

A closure technology which can result in indentations having such a low depth is described in EP 3916877 A1. After the insertion of an electrode-separator composite into a housing cup provided with a step, the step can be converted into a circumferential indentation by calibration of the external diameter of the housing cup. This indentation extends around the side wall of the housing cup in a ring shape, but does not have the depth which an indentation used for flanging would have to have.

The cover assembly preferably defines a closure plane, which is generally established by a part of the inner side of the cover assembly facing toward the interior of the housing. The less the axial distance is between the main areas of the anode and the cathode and the closure plane, the axially longer the main areas having the electrode material of the winding can be, which can be installed with identical external dimensions of the housing. In the energy storage element, an axial distance can be achieved between the main areas of the anode and the cathode and the closure plane which is between 0.6 mm and 3.0 mm, in particular between 0.8 mm and 2.5 mm, preferably between 1.0 mm and 2.0 mm, and preferably between 1.2 mm and 1.6 mm.

It is furthermore preferred that the cover assembly comprises a circumferential outer closure ring, which is enclosed by the seal, wherein the closure plane is bounded by the inner side of the closure ring facing toward the interior of the housing.

In preferred embodiments, the cover assembly comprises a metal disc, which is welded to a distance equalization structure in a connection area of the distance equalization structure, which
a) is provided by a distance equalization plate part connected to the contact plate part; or
b) is provided by the contact plate part.

In the latter case, the contact plate part thus comprises the distance equalization structure. A separate distance equalization structure is then not required.

Vice versa, the distance equalization plate part can have a contacting area, which functions as the contact plate part and is connected to the free edge strip of the anode current collector or to the free edge strip of the cathode current collector.

The metal disc can provide a CID function (CID=current interrupt device), which will be explained in more detail hereinafter.

The energy storage element is preferably distinguished by at least one of the following features:
a) A support ring is provided between the distance equalization plate part and the metal disc, which is a separate component or is comprised by the seal, wherein the support ring is in direct contact with the distance equalization plate part and the metal disc;
b) The seal comprises a support section, using which it is supported on the contact plate part or on an area of the distance equalization plate part.

The support ring or the support section fulfils a securing function, specifically it prevents the distance equalization plate part and/or the contact plate part from being raised jointly with the metal disc in the case of a pressure increase in the housing, which is required in conjunction with the mentioned CID function.

For the purpose of providing the CID function, the distance equalization structure can have a material weakening, in particular a groove, flanking or even defining the connecting area of the distance equalization structure.

In addition, it can be advantageous if the metal disc is designed as a PRV (pressure relief valve) and for this purpose comprises a material weakening, for example, a weakening groove in the form of a ring or circular ring.

The PVR will also be discussed in greater detail hereinafter.

In addition, the present disclosure provides a method for the production of such an energy storage element, the method having the following steps:
(A) providing the housing having the metallic housing cup and the cover assembly;
(B) providing the seal arrangement having the seal and providing the support ring;
(C) providing the electrode-separator composite;
(D) connecting, in particular welding, the contact plate part to the edge strip of the anode current collector or to the edge strip of the cathode current collector;
(E) positioning the seal and the support ring;
(F) connecting the cover assembly to the contact plate part;
(G) closing the housing cup.

The method further includes the following steps:
(H) compressing the edge strips in the axial direction or bending over the edge strips, in particular before or during the performance of step (D);
(I) performing steps (D), (E) and (F), and (H) outside the housing cup, so that a cover winding composite is formed;
(K) introducing the cover winding composite and the seal into the housing cup before performing step (G).

It was recognized according to the present disclosure that eliminating a tool engagement structure advantageously enables a cover winding composite to be prefinished as an assembly and only introduced into the housing cup thereafter.

With regard to the CID function and the variants of the distance equalization structure, it is advantageous here if:
(L) the distance equalization structure is provided by the distance equalization plate part and in step (F) the cover assembly is connected to the distance equalization structure and the distance equalization plate part is connected to the contact plate part;
or
(M) the distance equalization structure is provided by the contact plate part and in step (F) the cover assembly is connected to the distance equalization structure.

### Energy Storage Cell According to the Prior Art

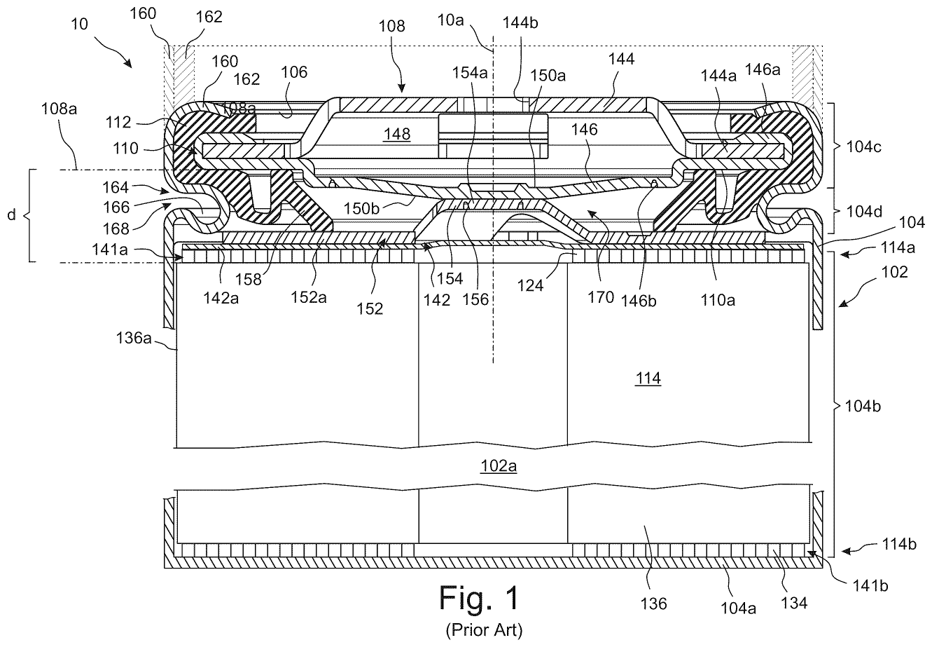

FIG. 1 shows an energy storage element by way of example in the form of an energy storage cell 10 having a basic structure as is known, for example, from above-mentioned European patent application number 23190399.8 of the applicant.

The energy storage cell 10 comprises a housing 102, which is closed airtight and liquid-tight and delimits an interior 102a and defines a longitudinal axis 10a of the energy storage cell 10. The housing 102 comprises a metallic housing cup 104, which has a terminal circular opening 106. The housing cup 104 comprises, in the axial direction, a base 104a, a cylindrical central section 104b, and a closure section 104c.

In addition, the housing 102 comprises a cover assembly 108, which is arranged in the closure section 104c and closes the opening 106. The cover assembly 108 comprises a circumferential outer closure ring 110, which extends transversely to the longitudinal axis 10a of the energy storage cell 10. The energy storage cell 10 furthermore has a seal arrangement having a ring-shaped seal 112 made of an electrically insulating material, which radially encloses the cover assembly 108 and seals against the housing cup 104. In the present exemplary embodiment, the seal 112 encloses the closure ring 110 of the cover assembly 108 and electrically isolates the housing cup 104 and the cover assembly 108 from one another.

A closure plane 108a of the cover assembly 108 is bounded by the inner side 110a of the closure ring 110 of the cover assembly 108, which faces toward the interior 102a of the housing 102.

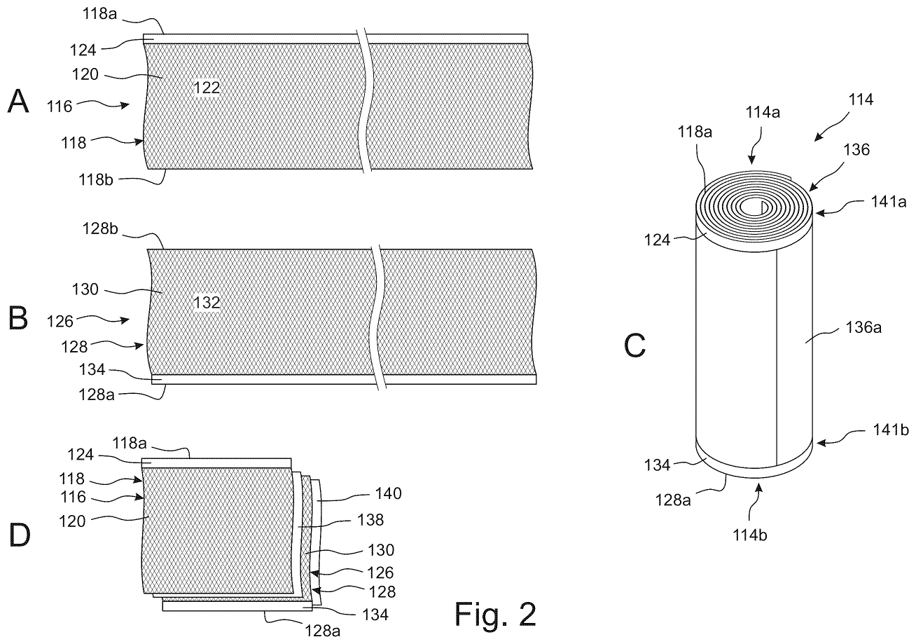

The energy storage cell 10 comprises an electrode-separator composite 114, which is housed in the housing cup 104 and the structure of which is illustrated in FIG. 2.

The electrode-separator composite 114 comprises a band-shaped anode 116 having a band-shaped anode current collector 118, which has a first longitudinal edge 118a and a second longitudinal edge 118b parallel thereto. The anode current collector 118 is a foil made of copper or nickel. The anode current collector 118 has a band-shaped main area 120, which is loaded with a layer made of negative electrode material 122, and a free edge strip 124, which comprises the first longitudinal edge 118a of the anode current collector 118 and is not loaded with the negative electrode material 122.

Furthermore, the electrode-separator composite 114 comprises a band-shaped cathode 126 having a band-shaped cathode current collector 128, which has a first longitudinal edge 128a and a second longitudinal edge 128b parallel thereto. The cathode current collector 128 is an aluminium foil. The cathode current collector 128 has a band-shaped main area 130, which is loaded with a layer made of positive electrode material 132, and a free edge strip 134, which comprises the first longitudinal edge 128a of the cathode current collector 128 and is not loaded with the positive electrode material 132.

FIGS. 2A and 2B respectively show the anode 116 and the cathode 126 individually in an unwound state. FIG. 2C illustrates the electrode-separator composite 114 in the form of the winding 136, as it can be used in an energy storage cell 10 and in which the anode 116 and the cathode 126 are wound up. The winding 136 moreover comprises a first and a second band-shaped separator 138 and 140, which separate the anode 116 and the cathode 126 from one another in the winding 136. In the present exemplary embodiment, a repeating sequence anode 116/separator 138/cathode 126/separator 140 results in the winding 136 in this manner, wherein the sequence begins with the anode 116 or the cathode 126 depending on the outer layer. A winding jacket 136a is formed by a plastic film.

The separators 138 and 140 can be seen in FIG. 2D, which additionally illustrates that the anode 116 and the cathode 126 are arranged offset in relation to one another inside the winding 136 such that the free edge strip 124 emerges with the first longitudinal edge 118a of the anode current collector 118 from a first terminal end face 114a and the free edge strip 134 emerges with the first longitudinal edge 128a of the cathode current collector 128 from the second terminal end face 114b of the electrode-separator composite 114.

In this way, the free edge strip 124 of the anode current collector 118 forms a protrusion 141a at the first end face 114a of the electrode-separator composite 114. In a corresponding manner, the free edge strip 134 of the cathode current collector 128 forms a protrusion 141b at the second end face 114b of the electrode-separator composite 114. Both protrusions are shown uncompressed here.

These end faces 114a and 114b are therefore also the corresponding end faces of the winding 136. FIG. 2C shows the winding 136 and its components in its winding configuration, in which in particular the edge strip 124 of the anode current collector 118 and the edge strip 134 of the cathode current collector 128—and therefore the protrusions 141a and 141b formed by the free edge strips 124 and 134—protrude in the axial direction unloaded by forces and freely in relation to the winding 136.

In the energy storage cell 10, the cathode current collector 128 of the winding 134 is preferably welded over its entire length with its free edge strip 134 directly to the base 104a of the housing cup 104. In other embodiments, the edge strip 134 can be welded to a metal plate, which is seated flatly on the edge strip and which is in turn electrically connected to the base 104, for example, likewise by welding.

The anode current collector 118 of the winding 134 is connected with its free edge strip 124 by welding to a contact plate part 142, which is seated with a ring-shaped contacting area 142a on the free edge strip 124, in particular the first longitudinal edge 128a of the anode current collector 118, and covers the first terminal end face 114a of the electrode-separator composite 114 or the winding 136.

In a modification, the installation of the winding 136 can also take place in reverse in this manner. In this case, the anode current collector 118 is thus welded with its free edge strip 124 to the base 104a of the housing cup 104, whereas the cathode current collector 128 is connected to the contact plate part 142.

The cover assembly 108 of the energy storage cell 10 comprises an externally accessible polar hat 144, which is electrically conductively connected via an outer ring area 144a to a metal disc 146 formed complementary thereto and is seated thereon, wherein an intermediate space 148 remains between the polar hat 144 and the metal disc 146. In the exemplary embodiment explained here, the outer edge area 146a of the metal disc 146 is bent over on the outside around the ring area 144a of the polar hat 144, by which the closure ring 110 of the cover assembly 108 is formed. The metal disc 146 delimits the interior 102a of the housing 102 and thus defines an outer side 150a facing away from the interior 102a and an inner side 150b facing toward the interior 102a.

The metal disc 146 is moreover designed as a PRV (pressure relief valve) and for this purpose comprises a ring-shaped material weakening, which is formed in the present exemplary embodiment by a circular elongated weakening groove 146b. When the pressure in the interior of the housing 102 exceeds a predefined limiting value, the metal disc 146 tears open along the groove 146b.

A distance equalization plate part 152, which has a ring-shaped contacting area 152a, using which it is welded onto the contact plate part 142, is arranged between the metal disc 146 of the cover assembly 108 and the contact plate part 142 on the winding 134. The ring-shaped contacting area 152a merges radially inward into a distance equalization structure 154, which extends out of the plane of the contacting area 152a like a dome in the direction of the metal disc 146. The distance equalization structure 154 is connected in a connection area 154a by welding to the inner side 146b of the metal disc 146, which rests directly on this connecting area 154a. The connecting area 154a of the distance equalization plate part 152 is delimited by a groove 156 in the form of a ring or circular ring, which encloses the connecting area 154a.

This groove 156 in the distance equalization structure 154 is an example of a material weakening, which flanks the connecting area 154a and ensures the so-called CID function (current interrupt device). When the pressure in the interior of the housing 102 rises, the metal disc 146 bulges outward. Due to the welded connection between the metal disc 146 and the distance equalization structure 154, the bulging membrane exerts a tensile force on the distance equalization structure 154 of the distance equalization plate part 152. When this force is strong enough, its connecting area 154a is torn out of the distance equalization structure 154 along the groove 156. The direct contact and the electrical connection between the metal disc 146 and the distance equalization plate part 152 are thus interrupted and a hole remains in the upper part of the distance equalization structure 154.

The distance equalization plate part 152 and the contact plate part 142 can moreover also be replaced by a component which assumes the functions of both elements. It would thus be possible, for example, to weld the contacting area 152a directly on the edge strip 124 while eliminating the contact plate part 142. This also applies in principle to cells according to the present disclosure, in particular those described hereinafter.

In order that the metal disc 146 and the distance equalization plate part 152 can be welded to one another from the outside, the polar hat 144 has, in addition to further openings which are not designated separately, in particular a passage hole 144b, through which the metal disc 146 is accessible in the overlap area to the connecting area 154a of the distance equalization plate part 152 for a laser from outside the housing 102.

The energy storage cell 10 additionally comprises a support ring 158, which is clamped between the metal disc 142 and the distance equalization plate part 152. The support ring 158 rests on the ring-shaped contacting area 152a of the distance equalization plate part 152 and presses from below against the metal disc 146 in the outer edge area 146a thereof. In the present case, the support ring 158 is a part of the seal 112, but this does not necessarily have to be the case.

The support ring 158 provides a further security function: Specifically, there is the risk that in the event of a pressure increase in the housing 102, the entire distance equalization plate part 152 will be raised as such, possibly together with the contact plate part 142, due to the above-explained tensile force on the distance equalization structure 154, without the connecting area 154a tearing out. In this case, the CID does not function.

However, such a situation is avoided by the support ring 158. If the metal disc 146 bulges outward, the support ring 158 holds the distance equalization plate part 152 in its place and ensures tearing out of the connecting area 154a, by which the function of the CID is ensured.

In particular a conventional flanging method is used for closing the circular opening 106 of the housing cup 104 by way of the cover assembly 108. The housing cup 104 has a free end section 160, which is initially cylindrical or possibly even slightly conical before the closing; this is illustrated in FIG. 1 by dashed lines. The seal 112 also has a free end section designated by 162, which preferably extends radially inward adjacent to the end section 160 of the housing cup 104 before the closing; this is also shown in FIG. 1 by dashed lines.

In the flanging method, the free end section 160 of the housing cup 140 is bent over radially inward, wherein the seal 112 is carried along by the free end section 106 and is wrapped around the closure ring 110 of the cover assembly 108 in this case. As a result, the seal 112 is compressed by the free end section 160 of the housing cup 104, which is bent over radially inward, in the axial direction against the cover assembly 108.

In order to keep axial forces acting in the direction of the cup base 104a away from the winding 136 or the electrode-separator composite 114 in this case, the housing 102 has a tool section 104d in the axial direction between the central section 104b and the closure section 104c, in which a tool engagement structure 164 is formed in the housing cup 104.

The tool engagement structure 164 has the function that it has an embossment in the radial direction into the interior 102a of the housing, so that a tool can be applied to the housing 102 when the opening 106 or the housing cup 104 is closed. A countering tool engages from the outside in the tool engagement structure 164 during the closing of the opening 106, which supports the housing cup 104 in the axial direction against the force acting during the flanging method and dissipates this force, so that the winding 136 remains substantially free of a force action.

In order that a corresponding tool can be applied to the housing 102, the tool engagement structure 164 occupies an area of the housing interior 102a, which is no longer available for the winding 136 due to the cross section thus reduced. The position of the tool engagement structure 164 in the axial direction determines the distance d between the main areas 120, 130 of the anode 116 or cathode 126 and the closure plane 108a of the closure assembly 108, which is designated by d in FIG. 1.

The axial extensions of the cover assembly 108 and the distance equalization plate part 152 and the contact plate part 142 are matched to this distance d. In particular, the domed distance equalization structure 154 of the distance equalization plate part 152 bridges the intermediate space 170 here between the contact plate part 142 and the inner side 150b of the metal disc 146, into which the tool engagement structure 164 protrudes.

In the energy storage cell 10 shown in FIG. 1, the tool engagement structure 164 is formed by a bead 166, which points radially inward and is completely circumferential in the circumferential direction, and which provides a tool engagement bead 168. However, other structures are also conceivable.

In the construction of this energy storage cell 10, the tool engagement structure 164 and, specifically here the tool engagement bead 168, is first created after the winding 136 has already been arranged in the interior 102a of the housing 102. Otherwise, the winding 136 would strike against the tool engagement bead 168 and the path into the interior 102a would be blocked due to the smaller cross section there. The cover assembly 108 is then placed with the seal 112 on the tool engagement bead 168 and the flanging procedure takes place.

It is furthermore to be noted in this case that the bead shown has a slight undercut. This can be the result of a height calibration, which can take place, for example, during the flanging or also thereafter. The bead 166 is preferably initially formed for the engagement of the tool without the visible undercut. The undercut is first formed during the calibration.

### Energy Storage Cells According to the Present Disclosure

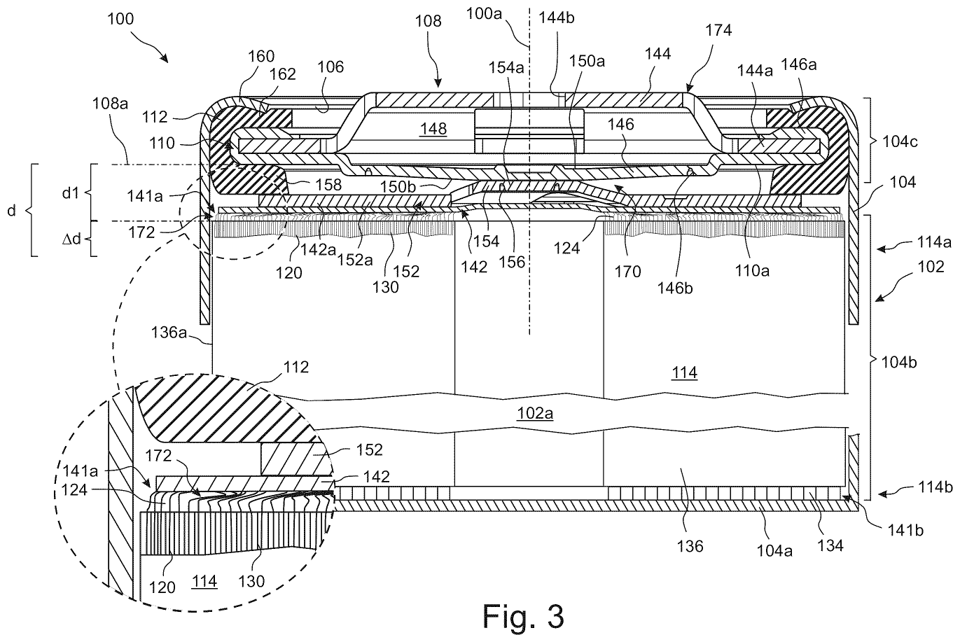

FIGS. 3 to 7 illustrate energy storage cells 100, wherein functionally corresponding components and parts bear the same reference signs as in the energy storage cell 10 according to FIG. 1; only the longitudinal axis now bears the reference sign 100a. The statements made on the energy storage cell 10 for FIGS. 1 and 2 apply accordingly to these parts and components, if not explained differently.

In the energy storage cell 100, the protrusion 141a formed by the edge strip 124 of the anode current collector 118 between the main area 120 of the anode current collector 118 and the contact plate part 142 is compressed in the axial direction in relation to the winding 136. In particular, the edge strip 124 is compressed and/or bent over for this purpose. FIG. 3 illustrates this on the basis of the detail enlargement therein. This protrusion 141a of the anode current collector 118 compressed in the axial direction is designated separately by 172. The energy storage cell 100 therefore comprises an electrode-separator composite 114 having a protrusion 172 compressed in the axial direction. In the arrangement of the winding 136 shown in the figures, this compressed protrusion 172 is the protrusion 141a of the anode current collector 118 formed by the edge strip 124; in the above-explained inverted arrangement (not shown separately here) of the winding 136, the compressed protrusion 172 is the protrusion 141b of the cathode current collector 128 formed by the edge strip 134. The winding 136 is shown with a partial view of the anode main area 120 and the cathode main area 130, in which the separators 138, 140 are not shown for the sake of clarity, however.

The bending over can take place, for example, in the manner described in above-mentioned European patent application number 23202968.6, in that the outer free turns of the edge strip 124 of the anode current collector 118 are bent over radially inward and moreover similarly compressed with the turns of the edge strip 124 located further radially inward upon the placement of the contact plate part 142 before the welding. For example, the edge strip can be bent over by an angle in the range of 30-90°. The edge strip can also be notched for this purpose, which is not absolutely necessary, however.

A compression can take place, for example, in that the contact plate is pressed onto the edge strip such that it is deformed. In many cases, this does not result in directed bending over, but rather in undirected compression. Sections of the edge strip can thus be bent over radially outward and other sections can be bent over radially inward.

Both the bending and the compression result in a support surface which is formed by a protrusion compacted or consolidated as a result of the bending over and/or the compression.

Expressed in general terms, a protrusion 172 compressed in the axial direction has a higher stability and carrying capacity against forces which act in the axial direction on the compressed protrusion 172 than is the case with a protrusion 141a, 141b in the unloaded winding configuration explained above for FIG. 2.

The compressed protrusion 172 has a lesser axial extension here than a protrusion 141a, 141b in said winding configuration. The axial extension of a protrusion 172 compressed in the axial direction is in particular between 10% and 80% here, preferably between 15% and 60%, still more preferably between 15% and 50%, and furthermore preferably between 25% and 45% of the axial extension of a protrusion 141a, 141b in the unloaded winding configuration. The compressed protrusion 172 can possibly also be compressed to an axial extension which is less than 10% of the axial extension of the protrusion 141a, 141b in the unloaded winding configuration.

In the energy storage cells 100 shown here, the housing cup 104 is formed without a tool engagement structure 164. There is thus no tool engagement structure 164, whether in the form of a tool engagement bead 166 or in the form of another structure having a corresponding function, which is used during the closing of the opening 106 of the housing cup 104 to apply a tool to the housing cup, as was explained above.

Due to the compressed or bent-over edge strip 172 of the anode current collector 118, the electrode-separator composite 114, i.e. the winding 136 as such, but also with the welded-on contact plate part 142, is sufficiently stable to counteract the axial forces acting during closing as a counter element, so that the end section 160 of the housing cup can be bent over without the risk that the winding 136 will be damaged.

Different closing methods are used here than in the case of a housing having tool engagement structure. For example, radial bending over can be carried out by rotating rollers, which travel along the free end section 160 of the housing cup 104 in the circumferential direction and press radially inward and in the axial direction toward the cup base 104a in this case. Work steps can be omitted here, which are possibly necessary in the case of an energy storage cell 100 having a housing 102 having tool engagement structure 164, for example, the above-mentioned height calibration.

Because no tool engagement structure is provided, the housing cup 104 can be formed cylindrically from the base 104a to the closure section 104c. In relation to a housing 102 having tool engagement structure 164, which is otherwise identical, the intermediate space 170 between the contact plate part 142 and the inner side 150b of the metal disc 146 can therefore be kept shorter in the axial direction, due to which the winding 136 can be formed longer in the axial direction. A longer winding 136 in the axial direction results in an energy storage cell 100 having higher capacity and performance with otherwise unchanged external dimensions.

In FIG. 3, the axial distance between the main areas 120, 130 of the anode 116 and the cathode 126 and the closure plane 108a of the cover assembly is designated by d1. For comparison, FIG. 3 also once again shows the corresponding distance d in the energy storage cell 100 having tool engagement structure 164 according to FIG. 1.

As is apparent, the distance d1 is less by Ad than the distance d and the winding 136 has an axial extension greater by Ad of the main areas 120, 130 of the anode 116 and the cathode 126 than the winding 136 according to FIG. 1. The cover assembly 108 and the distance equalization plate part 152 are adapted to the intermediate space 170, which is now shortened in the axial direction. In particular the domed distance equalization structure 154 of the distance equalization plate part 152 is formed significantly flatter, which is shown by a comparison to FIG. 1. In the present exemplary embodiment, the metal disc 142 was also adapted, which bulges in the direction toward the distance equalization plate part 152 in the area delimited on the radial outside by the groove 146b. This bulging is now less, as also shown by a comparison to FIG. 1.

The housing 102 of the energy storage cell 100 is preferably between 50 mm and 150 mm long or tall. Its diameter is preferably in the range of 15 mm to 60 mm. In a preferred embodiment, it has the format 21700.

With otherwise unchanged housing 102, by way of the combination of a winding 136 having compressed protrusion 172 and the housing 102 without tool engagement structure, values for d1 can be achieved, for example, of between 0.6 mm and 3.0 mm, in particular between 0.8 mm and 2.5 mm, preferably between 1.0 mm and 2.0 mm, and preferably between 1.2 mm and 1.6 mm and values for Ad can be achieved, for example, of between 1.2 mm and 2.5 mm, in particular between 1.8 mm and 2.2 mm, by which the main areas 120, 130 of the anode 116 and the cathode 126 can be formed longer in the axial direction. With the routine housing dimensions having a diameter of the winding between 15 mm and 60 mm, a capacity increase between 1% and 3% results with these values of Δd.

Overall, the values of d1, Ad and the resulting capacity increase are obviously dependent on the design and the basic dimensions of the energy storage element.

In the exemplary embodiment shown in FIG. 3, the support ring 158 is again part of the seal 112. The seal in particular has a C-shaped cross section here, wherein the support ring 158 is formed by the leg of the seal 112 which presses against the inner side 110a of the closure ring 110 of the cover assembly 108. This configuration is shown in FIG. 3.

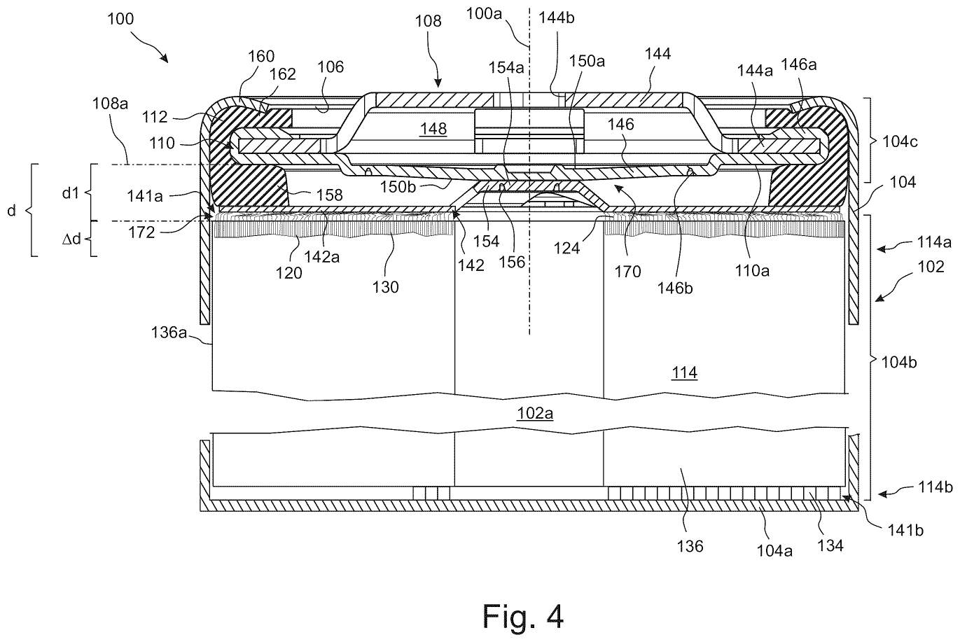

FIG. 4 shows a modification in which the distance equalization structure 154 is provided by the contact plate part 142. In this case, the contact plate part 142 is structurally formed corresponding to the distance equalization plate part 152 and the ring-shaped contacting area 142a of the contact plate part 142 merges radially inward into the distance equalization structure 154.

In this case, the support ring 158 is seated directly on the contact plate part 142. FIG. 4 shows this modification with unchanged distance d1, for which the distance equalization structure 154 has a corresponding axial extension. The seal 112 and the support ring 158 are adapted thereto. The distance d1 can be reduced once again accordingly, however, in that the distance equalization structure 154 is formed flatter in the manner as in the distance equalization plate part 152, which is shown in FIGS. 3, 5, and 6.

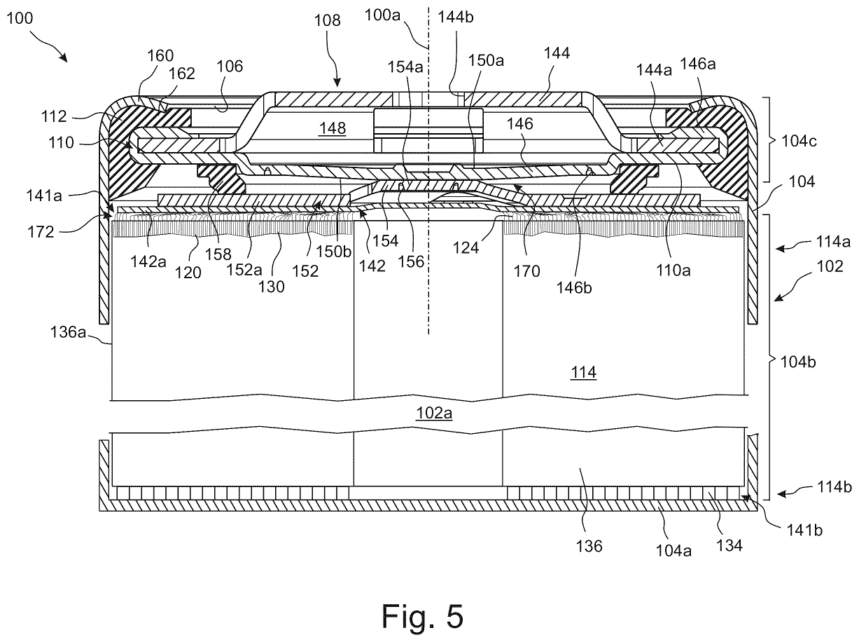

FIG. 5 shows a second exemplary embodiment of the energy storage cell, in which the seal 112 and the support ring 158 are formed as separate parts. A distance remains here between the seal 112 and the contact plate part 142.

In the modification, in which the distance equalization structure 154 is provided by the contact plate part 142, the support ring 158 is seated in this case directly on the contact plate part 142.

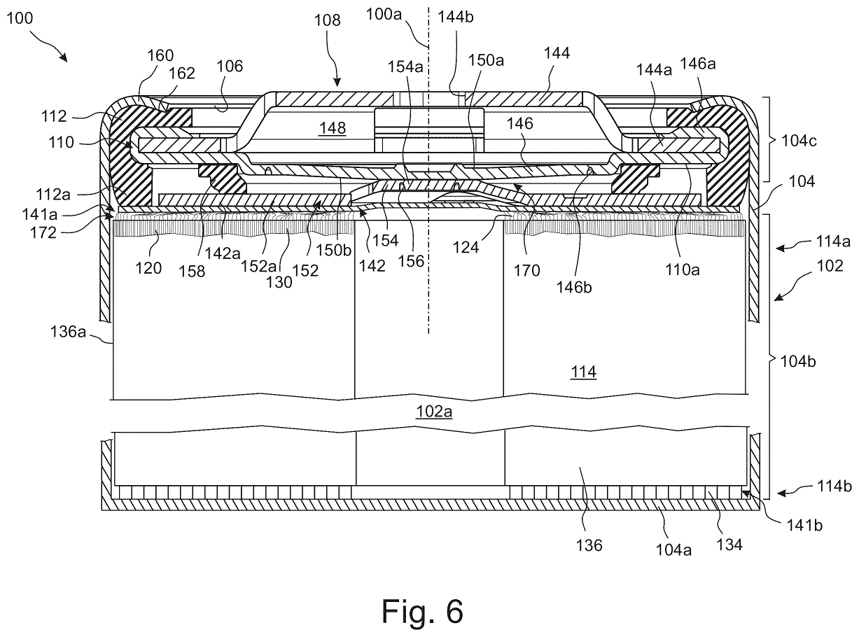

FIG. 6 shows a third exemplary embodiment of the energy storage cell 100, in which the seal 112 and the support ring 158 are also formed as separate parts. In contrast to the second exemplary embodiment, the seal 112 is supported on the contact plate part 142 and comprises a support section 112a for this purpose. The support section 112a of the seal 112 extends radially adjacent to the distance equalization plate part 152, which extends in the axial direction between the inner side 110a of the ring section 110 of the cover assembly 108 and the contact plate part 142.

In this case, the separate support ring 158 can be omitted, so that the support section 112a of the seal 112 forms the support ring 158 when the distance equalization structure 154 is provided by the contact plate part 142. The support ring 158 is then possibly formed by the support section 112a of the seal 112 so that it is seated farther radially inward on the contact plate part 142.

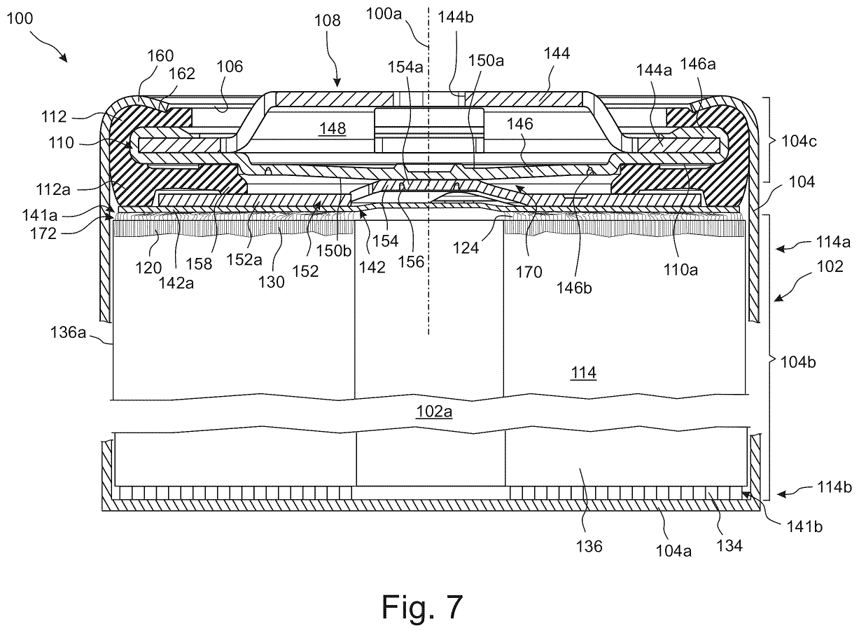

FIG. 7 shows a fourth exemplary embodiment of the energy storage cell 100, in which the seal 112 comprises both the support section 112a and the support ring 158.

Due to the elimination of the tool engagement structure, it is moreover possible that the winding 136 and the cover assembly 108 are already welded with one another before the insertion of the winding 136 into the housing 102, since there is no structure which blocks the passage for the winding 136 into the housing 102, as explained above with reference to FIG. 1.

This opens the path for the production method described at the outset, in which initially such a cover winding composite, which is only designated as a whole by 174 in FIG. 3, is manufactured and is then only introduced thereafter into the housing cup 104.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage element comprising:
a) a housing comprising a metallic housing cup and a cover assembly that closes the housing cup, the housing defining a longitudinal axis and an interior;
b) a seal arrangement comprising a seal that radially encloses the cover assembly and seals against the housing cup, wherein the seal is compressed against the cover assembly by a free end section of the housing cup that is bent over radially inward;
c) an electrode-separator composite having a sequence anode/separator/cathode/separator, the electrode-separator assembly being housed in the housing cup and is provided in the form of a cylindrical winding, wherein:
c1) the anode comprises an anode current collector having a band-shaped main area loaded with a layer of negative electrode material and a free edge strip not loaded with the negative electrode material, the anode current collector further having a first longitudinal edge, wherein the free edge strip emerges from a first terminal end face of the electrode-separator composite and forms a protrusion at the first end face;
c2) the cathode comprises a cathode current collector having a band-shaped main area loaded with a layer of positive electrode material, and a free edge strip not loaded with the positive electrode material, the cathode current collector further having a first longitudinal edge, wherein the free edge strip emerges from a second terminal end face of the electrode-separator composite and forms a protrusion at the second end face;
d) a contact plate part, wherein:
d1) the contact plate part is seated on the protrusion of the anode current collector and covers the first terminal end face of the electrode-separator composite and is connected thereto; or
d2) the contact plate part is seated on the protrusion of the cathode current collector and covers the second terminal end face of the electrode-separator composite and is connected thereto;
wherein:
e) the protrusion connected to the contact plate part is a protrusion compressed in the axial direction; and
f) the housing cup is formed without a tool engagement structure.

2. The energy storage element according to claim 1, wherein the cover assembly defines a closure plane and an axial distance between the main areas of the anode and the cathode and the closure plane is between 0.6 mm and 3.0 mm.

3. The energy storage element according to claim 2, wherein the cover assembly comprises a circumferential outer closure ring, which is enclosed by the seal, wherein the closure plane is delimited by the inner side of the closure ring facing toward the interior of the housing.

4. The energy storage element according to claim 3, wherein the cover assembly comprises a metal disc welded to a distance equalization structure in a connecting area of the distance equalization structure, which is provided by a distance equalization plate part connected to the contact plate part; or is provided by the contact plate part.

5. The energy storage element according to claim 4, wherein the distance equalization structure is provided by the distance equalization plate part,
wherein a support ring is provided between the distance equalization plate part and the metal disc, which is a separate part or is comprised by the seal, and
wherein a distance remains between the contact plate part and the seal in the axial direction or the seal comprises a support section with which it is supported on the contact plate part.

6. The energy storage element according to claim 4, wherein the distance equalization structure is provided by the contact plate part and a support ring is provided between the contact plate part and the metal disc, which is a separate part or is comprised by the seal.

7. The energy storage element according to claim 5, wherein the distance equalization structure provides a CID function and comprises a groove, flanking the connecting area of the distance equalization structure.

8. The energy storage element according to claim 5, wherein the metal disc is designed as a PRV and comprises a weakening groove in the form of a ring or a circular ring.

9. A method for producing an energy storage element according to claim 1, the method comprising:
(A) providing the housing having the metallic housing cup and the cover assembly;
(B) providing the seal arrangement having the seal and providing the support ring;
(C) providing the electrode-separator composite;
(D) connecting the contact plate part to the edge strip of the anode current collector or to the edge strip of the cathode current collector;
(E) positioning the seal and the support ring;
(F) connecting the cover assembly to the contact plate part;
(G) closing the housing cup;
(H) compressing the edge strips in the axial direction or bending the edge strips over;
(I) performing steps (D), (E), and (F) and (H) outside the housing cup, so that a cover winding composite is formed; and
(K) introducing the cover winding composite and the seal into the housing cup before performing step (G).

10. The method according to claim 9, wherein:
(L) the distance equalization structure is provided by the distance equalization plate part and in step (F) the cover assembly is connected to the distance equalization structure and the distance equalization plate part is connected to the contact plate part; or
(M) the distance equalization structure is provided by the contact plate part and in step (F) the cover assembly is connected to the distance equalization structure.
